(19) United States
(12) Patent Application Publication
(10) Pub. No.: US 2003/0234076 A1
(43) Pub. Date: Dec. 25, 2003

(54) Method for separating optical recording memory media layering

(76) Inventors: Jenn-Shing Wang, Yungkang City (TW); Pei-Chao Cheng, Yungkang City (TW)

Correspondence Address: Far East College, P.O. Box No. 6-57, Junghe, Taipei, 235, TW

(21) Appl. No.: 10/442,238

(22) Filed: May 21, 2003

(30) Foreign Application Priority Data
Jun. 20, 2002 (TW) 091113427

(51) Int. Cl. B32B 1/00

(52) U.S. Cl. 156/344

(57) ABSTRACT

A method for separating optical recording memory media substrate and its thin film material. It is to place the optical recording memory media under the electromagnetic wave environment, by the nature of electromagnetic wave characteristic to focus large amount of energy onto the optical recording memory media thin film layer, to break the bonding between the substrate and the thin film layer and effect an thorough separation between the substrate and the thin film layer. It is a simple method with easy operation, low cost, quick and thorough separation. It makes possible the high quality recovery of the substrate and thin film layer; it also eliminates any secondary pollution in the process.

### BACKGROUND OF THE INVENTION

1) Field of the Invention

The invention relates to a method for separating the optical recording memory media layering, specifically a method to place the optical recording memory media under an electromagnetic environment, exploiting the characteristic of the metal thin film on the optical recording memory media substrate absorbing the electromagnetic energy from the environment, breaking up the bonding between the substrate and the protective thin film layer, facilitating the recovery and recycle of compact disc products.

2) Description of the Prior Art

Optical recording memory media, according to their physical property, include the following major categories: compact disc-read only memory, compact disc write one time only, rewritable compact disc memory and etcetera. The compact disc read only memory, such as conventional compact discs, comprises basically a coated reflective layer on top of the substrate and a protective layer made in sequence. The compact disc one-time only memory, such as CD-R (CD-record), comprises a substrate with the following sequence of layers on top: a recording layer, a reflective layer and a protective layer. The rewritable compact disc memory, such as CD-RW (CD-rewrite), comprises a substrate with the following sequence of layers on top: a dielectric layer, a recording layer, a dielectric layer, a reflective layer and a protective layer.

All the above compact disc products have a substrate and one or many thin film layers as major components wherein, the substrate is made of materials that can access data from and is suitable for laser light penetration as used in data-recording, such as polycarbonate resin, acrylic resin, poly olefin resin, epoxy resin and etcetera.

As the above compact disc products are manufactured and used in large quantities, the disposal treatment of such products are becoming a problem as are damaged/disqualified compact disc products, outdated stock items or illegal copy products destined for destruction.

Presently, discarded compact disc product are either mechanically crushed and used for landfill or incinerated. Of the two methods: the landfill option is increasingly difficult as suitable sites are difficult to come by and the metallic ingredients in the optical recording thin film layers can cause secondary underground pollution; the latter method requires special incinerator and proper treatment for the produced gases before discharging into the atmosphere. Neither method is ideal in terms of cost and efficiency. From the point of resources recycling and reuse, both methods are undesirable because the recycle substrates can no longer be used in the optical-recording process but only as low cost raw plastic base stock. Conventional methods to recover compact disc products are far from ideal in term of pollution prevention, recycling and reuse of resources.

In response to such deficiencies, a number of patent registrations or related research materials are issued such as the U.S. Pat. No. 5,306,349 and the U.S. Pat. No. 6,066,229 where the stock of discarded compact discs are pretreated with chemical solvent then separated by means of ultra sound vibration. Also the U.S. Pat. No. 5,619,898 and Taiwan Patent Publication No. 464595 (Treatment for Discarded Compact Discs and Related Device and Compact Discs) both provide option of mechanical scraping of the top layer of thin film. Taiwan Patent Publication No. 443949 (Recovery of Compact Disc-Record) discloses a mechanical crushing method then applying solvents to separate the various ingredients for reuse. All above methods that involves chemical solvents causes pollution and liquid solution discharge problems. The mechanical scraping tends to damage the substrate and therefore made it impossible to recycle for optical recording memory media disc products. In summary, all above methods and equipments involve expensive, cumbersome and difficult support facilities that are inconvenient, complicated and time consuming.

Other method involves chemical treatment to recover substrates are also available such as Japan Patent Registration No. 2615277 and Japan Patent Publication No. 8-164524, only these treatment methods cause the substrate material to experience change of physical properties and are difficult to maintain a quality level expectancy while narrowing the range of recovered substrates, therefore still can not recycle entire compact disc for reuse on the high value, optical-recording process market but only as low cost raw plastic base stock. Also, chemical treatment of the polycarbonate base materials tends to affect its quality, made it difficult for reuse for the high value optical-recording market sector, it may even affect the mechanical properties of the compact disc for proper re-use. And of course, the treatment of the solvent solution still constitutes a difficult problem.

The present invention is thus aimed to improve or avoid these difficulties, providing a fast, non-polluting method for separating optical recording memory media layering, to develop an economical procedure to recycle compact disc product for reuse by the optical recording memory media industry.

### SUMMARY OF THE INVENTION

The present invention is to exploit the “selective” characteristic of electro-magnetic wave to mass large amount of energy in short time, to focus it on the metal reflective layer of the optical recording memory media, so the optical recording memory media layer absorbs the energy and breaks down the bonding to other layers, enable the optical recording layer substrate and thin film layer to separate quickly and efficiently, without any pollution but having all physical properties intact for reuse.

The present invention calls for treatment method that involves only simple operations and low cost to achieve the separation of compact discs with high efficiency, allowing for repeated recycles. It is a safe, dependable, low cost, high value re-use method to be considered.

### DETAILED DESCRIPTION OF THE PREFERRED EMBODIMENT

The invention herein relates to a method for separating compact disc optical data recording substrate and its thin film material. It utilizes electro-magnetic wave to break down the bonding between the substrate and the thin film layering, wherein the electromagnetic wave environment can be a microwave oven. For instance, to place the optical recording memory media into a microwave oven, apply the power source with the following set of parameters: frequency at 2450 MHz, power range at 100 W, time duration for 3 seconds to initiate the separation. The optical data recording media reflective layer and the paint coating layer are to separate or crack, causing radial crack on the reflective layer such that the thin film coating layer is to break down quickly and the substrate and thin film coating layer are to quickly and thoroughly separate.

The above separation is due to the selective nature of microwave to mass large amount of energy to focus onto the optical recording memory media metal layer (the reflective thin film layer) in short time, to make metal layer absorb the projected energy, causing a massive breakdown and thorough separation with the adjacent layers in very short time. It is an extremely effective as a separation method.

Since the separation method involves placing the optical data recording media in a microwave environment; it is possible to observe the progress through viewing window thereof.

In addition, mechanical scrapping or ultra-sound vibration method can further finish semi-finished products that have been through microwave separation process or vice versa, to apply microwave process to semi-finished products that have been through mechanical scrapping or ultra sound vibration method.

Also, during the microwave separation method, it is possible to apply airflow to blow off the loose fragments, further improving the efficiency in terms of time and energy spent.

There are the following fashions in placing the optical recording memory media into the microwave environment:

1. By different batches, to place the optical recording memory media into the microwave environment by batches.

2. Semi-continuous, optical recording memory media are placed into the microwave environment by transport belt then stopped to be microwave processed until the thorough separation is achieved, then shipped out of the microwave environment.

3. Continuous, optical recording memory media are placed on a belt in motion in the microwave environment to be processed until thorough separation is achieve then shipped out of the microwave environment.

All the modes above can reach the goal of separating the optical recording memory media layering, therefore suitable for the present method. All electromagnetic waves with frequency within the microwave range can serve to break down the reflective layer with similar effect.

The electro-magnetic wave that affects the reflective layer can also interact with the paint coating layer, the inter-conducting layer or the optical data recording layer, causing dissolving, evaporation, phase change and etcetera phenomena; and is therefore within the applicable range of the present invention.

The aforementioned optical recording memory media that can be successfully separated via microwave processing include: read only audio CD (compact disc), CD-ROM (compact disc-read only memory), video CD (compact disc), CD-I (compact disc-interactive), DVD-Video (digital versatile disc-video), DVD (digital versatile disc), DVD-ROM (digital versatile disc-read only memory), one time only compact disc-record, worm, DVD-RAM (digital versatile disc-random access memory), CD-RW (compact disc-rewrite), MO (magneto-optical disk drive), MD (mini disc) and DVD-RW (digital versatile disc-rewrite). All these above optical data recording memory media have the metal reflective layer needed to reflect laser light; the thin metal layer is to absorb the concentrated energy that causes the separation, any optical data recording media that has metal layering is suitable for the present invention.

Though the application of the separation via microwave process is targeted at the type of compact disc with substrate that has data recording layer, reflective layer and protective layer, but any semi-finished compact disc products that was damaged in the process, or disqualified products at final inspection or surplus stock items and etcetera are also applicable for the present invention. In other word, regardless of the types of the layer on top of the substrate, as long as there is metal ingredient in the layering then a process similar to the above method separating the substrate and the thin film layers can treat it.

To apply the present invention in the procedure of the “Recovery or Recycle Procedures of the Optical Data Recording Media”, the sequence of steps taken is as follow:

a. Categorization: to categorize the optical data recording media according to its ingredients (such as: gold, silver, aluminum, etc.) or according to the different substrate types.

b. Microwave separation: to separate the substrate and the thin film layers via microwave process, to break down the thin film layer quickly and separate the substrate.

c. Recovery and reuse: to recover the separated substrate material and the thin film material for recovery and reuse.

The application of the present invention in the “Recovery or Recycle Procedures of the Optical Data Recording Media” enable the recovery procedure of the optical recording memory media a higher efficiency and better cost effectiveness. Not only it recovers the valuable ingredients but also effectively limits the secondary pollution during the recovery.

It is thus evident that the present invention, by means of simple treatment, effectively separates the substrate and the thin film materials, recovering un-deformed, high purity substrate material; making recycling substrate possible. The efficient removal of optical data recording media layer from the substrate is to start the practice of reusing recycled substrate, drastically reduce the production cost.

The present invention also provide option to handle damaged semi-finished products, disqualified products during final inspection or surplus stock items; recycling the substrates for reuse, either for high quality substrate materials for other optical recording memory medias or simply as raw plastic base stock for packaging or personal computer shells and etcetera. It offers opportunities for multi-time recycling and effectively eliminates any secondary pollution.

It is of course to be understood that the embodiment described herein is merely illustrative of the principles of the invention and that a wide variety of the modifications thereto may be effected by persons skilled in the art without departing from the spirit and scope of the invention as set forth in the following claims.

1. A method for separating optical recording memory media layering, comprising the steps of:
(a) placing an optical recording memory media in an electromagnetic environment;
(b) exploiting an electromagnetic wave characteristic of focusing large amount of energy onto the optical recording memory media layer of thin film;
(c) breaking the bonding between substrate and the thin film materials, whereby separating the thin film from the substrate, and forming semi finished products.

2. The method for separating optical recording memory media layering of claim 1, wherein the semi finished products can be further treated by mechanical scrapping or ultra sound vibration to thoroughly separate the substrate and the thin film layer or have the semi finished products by mechanical or ultra sound vibration treatment to be further processed by the electromagnetic environment.

3. The method for separating optical recording memory media layering of claim 1, wherein the electromagnetic environment can be augmented by provision of airflow to enhance the efficiency.

4. The method for separating optical recording memory media layering of claim 1, wherein the placing of the optical data recording media into the electromagnetic environment can be executed by batches, semi continuously or continuously.

5. The method for separating optical recording memory media layering of claim 1, wherein the electromagnetic wave frequency is not less than that of the microwave frequency range.
